(19) United States
(12) Patent Application Publication
(10) Pub. No.: US 2013/0214072 A1
(43) Pub. Date: Aug. 22, 2013

(54) ROTARY CUTTER DOOR DEVICE FOR PAPER SHREDDERS

(71) Applicant: Chun Yu Wu, New Taipei City (TW)

(72) Inventor: Chun Yu Wu, New Taipei City (TW)

(73) Assignees: TEX YEAR INDUSTRIES INC., New Taipei City (TW); Tex Year Business Machine(SHEN ZHEN)CO.LTD., Shenzhen (CN)

(21) Appl. No.: 13/400,138

(22) Filed: Feb. 20, 2012

(51) Int. Cl. B02C 23/04

(52) U.S. Cl. 241/37.5

(57) ABSTRACT

The present invention discloses a rotary cutter door device for a paper shredder, comprising a guide rod, a guide plate assembly, a rotary bearing, and a cutter door installed above the spindle cutter, wherein the guide plate assembly includes a guide plate and its support, the guide plate is installed on the side wall of the spindle cutter through the guide plate support and can slide horizontally on the guide plate support; a first and a second groove are configured sidelong on the guide plate, the guide rod is mounted in the first groove, the rotary bearing is installed in the second groove and the rotary bearing is fixed with the rotary spindle of the cutter door. When the rotary cutter door device opens the upper cover of the paper shredder, the cutter door is closed and fingers and sundries cannot touch the blades, thus improving security.

### BACKGROUND OF THE INVENTION

1. Technical Field

The present invention relates to the technical field of paper shredders, and more specifically, to a rotary cutter door device and the paper shredder using it.

2. Description of Related Art

A paper shredder is an office apparatus, and with development of miniaturized and home offices, it has become more and more commonly used in regular families.

A common paper shredder comprises a machine body at the upper part and a dustbin body configured at the lower part, wherein the machine body comprises a paper inlet, a cutter assembly accommodated in the machine body under the paper inlet, which is connected with the control circuit. The existing paper shredder is configured with an automatic breaker mechanism, the cutters will not operate when opening the cover and the motor is grounded so as to ensure that the metal cutters are neutral. However, when the circuit has an unexpected fault, danger may also occur. Since the inlet of large paper shredders is also large and the fingers of children are tiny, when the fingers are put into the inlet of the paper shredder by accident, the blades inside the paper shredder will wrench the fingers of the child, which has safety hazards, or if some sundries fall into the paper shredder, the blades may be damaged.

### BRIEF SUMMARY OF THE INVENTION

The present invention aims at providing a rotary cutter door device for paper shredders, which is capable of overcoming the existing defects, avoiding injury to the users caused by using the cutters, and protecting the cutters from being damaged by incorrect use by the users.

To realize the purpose above, the present invention uses the technical solution below:

A rotary cutter door device for a paper shredder, including a guide rod, a guide plate assembly, a rotary bearing and a cutter door installed above the spindle cutter of the paper shredder, wherein the guide plate assembly includes a guide plate and a guide plate support, the guide plate is installed on the side wall of the spindle cutter of the paper shredder through the guide plate support and can slide horizontally on the guide plate support; a first chute and a second chute is configured sidelong on the guide plate, the guide rod is mounted in the first chute, the rotary bearing is installed in the second chute and the rotary bearing is fixed with the rotary spindle of the cutter door.

The rotary cutter door device of the paper shredder above further includes a tension spring, wherein one end of the tension spring is fixed on the guide plate and the other end is fixed on the paper shredder.

A third chute is further configured horizontally on the guide plate above, wherein the guide plate support is configured in the third chute and the guide plate can slide horizontally on the guide plate support.

Preferably, there are two guide plate supports, wherein one is configured under the guide plate and the other is configured in the third chute.

Preferably, there are three guide plate supports, a fourth chute is configured horizontally on the guide plate and the third guide plate support is configured in the fourth chute.

Preferably, there are four guide plate supports and the fourth guide plate support is stuck and fixed under the guide plate.

After using the technical solution above, the present invention features the following advantages:

1. The upper cover of the paper shredder is connected with the guide rod of the cutter door, when the upper cover of the paper shredder is opened, the cutter door is closed, so that human fingers and sundries cannot touch the spindle cutter; when the upper cover of the paper shredder is closed, the cutter door is opened and the paper shredder operates normally. Thus, the security of the paper shredder is improved.

2. A tension spring is fixed horizontally on one side of the cutter device, which has an effect of vibration reduction and buffering.

3. The present invention features compact structure, simple manufacturing and low cost.

### BRIEF DESCRIPTION OF THE SEVERAL VIEWS OF THE DRAWINGS

FIG. 1 is the structure perspective view of the present invention when the guide rod is above the chute.

FIG. 2 is the front view of the present invention when the guide rod is above the chute.

FIG. 3 is the structure perspective view of the present invention when the guide rod is under the chute.

FIG. 4 is the front view of the present invention when the guide rod is under the chute.

FIG. 5 is the schematic diagram of the using state when the rod guide installed on the paper shredder is above the chute.

FIG. 6 is the schematic diagram of the using state when the rod guide installed on the paper shredder is under the chute.

### BRIEF DESCRIPTION OF THE REFERENCE NUMERALS OF MAJOR COMPONENTS

100: guide rod, 200: guide plate assembly, 210: guide plate, 220: guide plate support.

230: the first chute, 240: the second chute, 250: the third chute, 260: the fourth chute,

300: rotary bearing, 400: cutter door,

500: tension spring, 600: spindle cutter, 700: side wall,

800: paper feeding roller mechanism

### DETAILED DESCRIPTION OF THE INVENTION

To make the purpose, technical solution, and advantages of the present invention clear, further description of the present invention will be given in conjunction with the drawings and embodiments in the following paragraphs. It shall be understood that the embodiments described herein are only to illustrate the present invention rather than limit it.

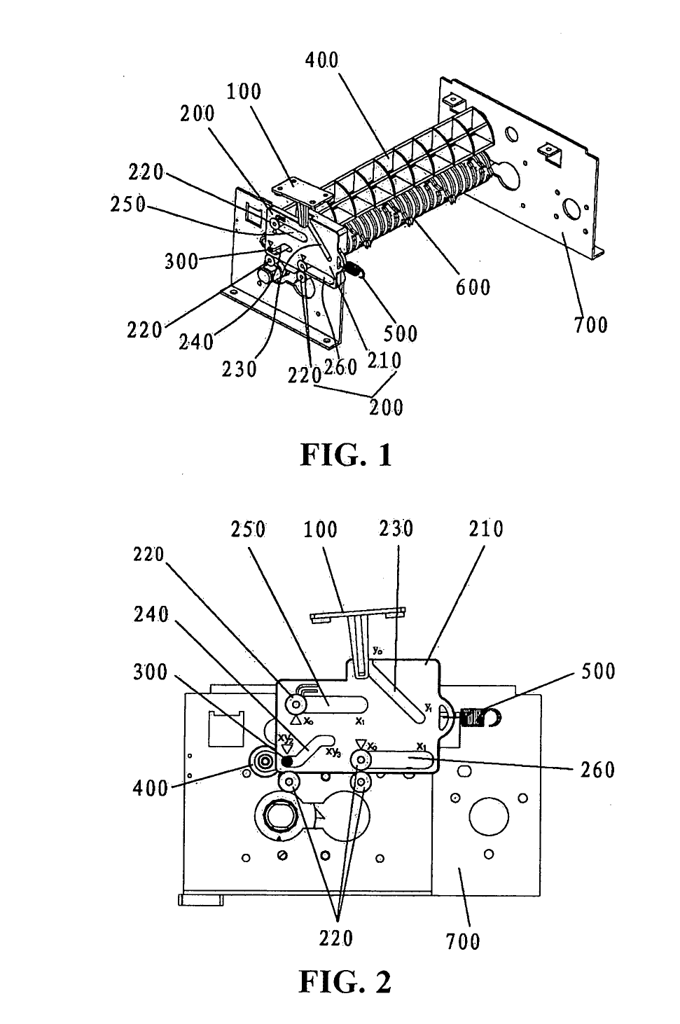

As shown in FIG. 1, the present invention discloses a rotary cutter door device for paper shredders, including a guide rod 100, a guide plate assembly 200, a rotary bearing 300, a cutter door 400, a tension spring 500 and a spindle cutter 600, wherein:

The guide plate assembly 200 includes a guide plate 210 and guide plate supports 220, and the guide plate 210 is fixed and supported on the side wall 700 of the spindle cutter 600 of the paper shredder through four guide plate supports 220, wherein:

A first chute 230, a second chute 240, a third chute 250 and a fourth chute 260 are configured on the guide plate 210, the guide rod 100 is in the first chute 230 of the guide plate 210 which is an incline section, when the guide rod 100 moves downward under the power, the guide plate 210 is driven to move to the left; the rotary bearing 300 is installed in the second chute 240 of the guide plate 210 which is composed of a horizontal section and an incline section, and is fixed on the rotary spindle of the cutter door 400.

Among the four guide plate supports 220, two guide plate supports 220 are located at the bottom end of the guide plate 210, used to support the guide plate 210, a guide plate support 220 is located in the third chute 250 and a guide plate support 220 is located in the fourth chute 260, so that the guide plate 210 can only slide horizontally. One side of the guide plate 210 fix a tension spring 500 and the other side of the tension spring 500 is fixed on the fixed column of the paper shredder.

The cutter door 400 is located above the spindle cutter 600 of the paper shredder.

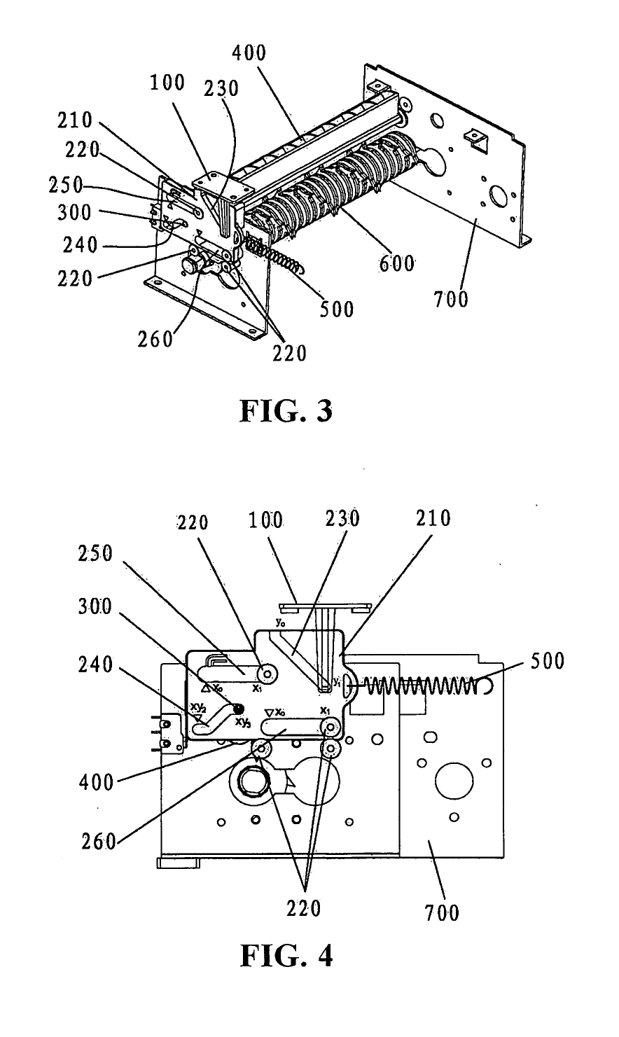

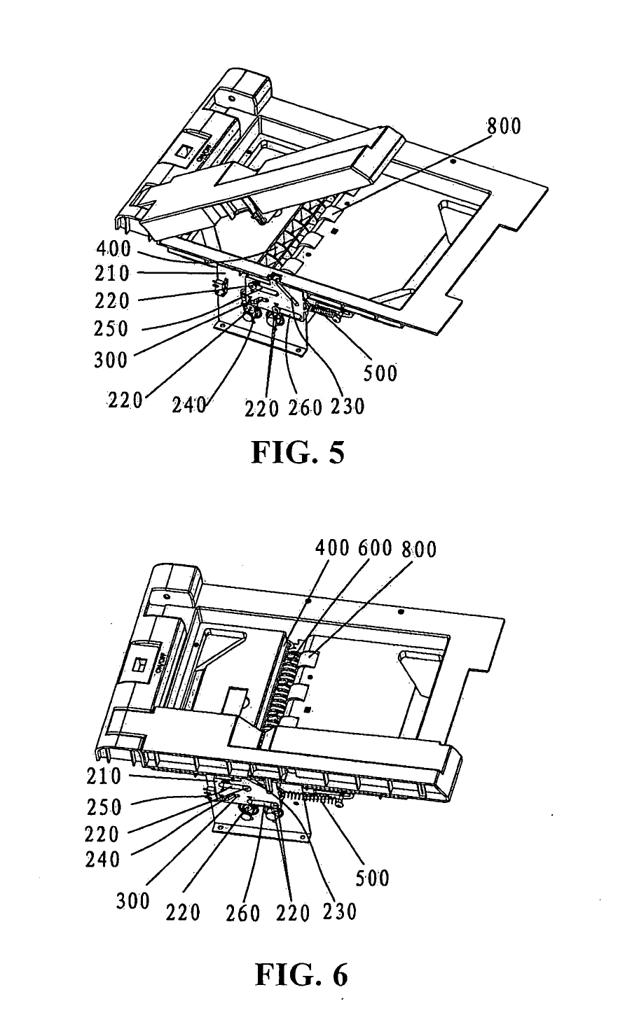

As shown in FIGS. 5 and 6, the paper shredder includes two spindle cutters 600, a rotary cutter door device and a paper feeding roller mechanism 800 are above the two spindle cutters 600, the tension spring 500 is connected to the fixed column of the paper shredder, the upper end surface of the guide rod 100 is locked on the upper cover of the paper shredder and moves in the first chute 230 with the opening and closing of the upper cover. The guide rod 100 moves along the first chute 230 and drives the guide plate 210 to move horizontally, thus driving the rotary bearing 300 to move in the second chute 240 and finally driving the cutter door 400 to rotate. FIG. 5 is the schematic diagram of the operating state of the paper shredder when the upper cover is open, the operating state of the rotary cutter door device is as shown in FIGS. 1 and 2, and FIG. 6 is the schematic diagram of the operating state of the paper shredder when the upper cover is closed, the operating state of the rotary cutter door is as shown in FIGS. 3 and 4, and further illustration of the two operating states will be given below:

As shown in FIGS. 1 and 2, at this time, the guide rod 100 is risen, the upper cover fixed with the guide rod 100 is open, the rotary bearing 300 is located at xy₂ of the second chute 240, the guide plate supports 220 in the third chute 250 and the fourth chute 260 are both at x₀, at this time, the cutter door 400 is closed, the tension spring 500 is compressed and human fingers and other sundries cannot touch the spindle cutter 600, thus improving the security of the paper shredder.

When the upper cover is closed, as shown in FIGS. 3 and 4, the guide rod 100 is compressed into the track of the first chute 230 from y₀ to y₁, and at the same time, the guide plate 210 moves to the left, the guide plate supports 220 in the third chute 250 and the fourth chute 260 move from x₀ to x₁, the rotary bearing 300 moves from xy₂ to xy₃ in the second chute 240, the tension spring 500 is in tension state and the cutter door 400 rotates for 90 degrees, in this way, the cutter door is opened and the machine is in operating state.

As shown in FIGS. 5 and 6, the present invention also provides a paper shredder which includes the rotary cutter door device described above.

The description above is only to illustrate the preferred embodiments but not to limit the protection scope of the utility model. Any changes and alternations in the technical scope disclosed by the utility that can be easily thought by the technical personnel skilled in the technical art shall be covered in the protection scope of the utility model. Therefore, the protection scope of the utility model shall be that of the Claims.

What is claimed is:

1. A rotary cutter door device for paper shredders, characterized in that, it is comprised of a guide rod, a guide plate assembly, a rotary bearing and a cutter door installed above the spindle cutter of the paper shredder, wherein the guide plate assembly includes a guide plate and a guide plate support, the guide plate is installed on the side wall of the spindle cutter of the paper shredder through the guide plate support and can slide horizontally on the guide plate support; a first groove and a second groove are configured sidelong on the guide plate, the guide rod is mounted in the first groove, the rotary bearing is installed in the second groove and the rotary bearing is fixed with the rotary spindle of the cutter door.

2. The rotary cutter door device of the paper shredder according to claim 1, characterized in that it further includes a tension spring, wherein one end of the tension spring is fixed on the guide plate and the other end is fixed on the paper shredder.

3. The rotary cutter door device according to claim 1 or 2, characterized in that the first chute is an incline chute.

4. The rotary cutter door device according to claim 3, characterized in that the second chute is composed of a horizontal section and an incline section.

5. The rotary cutter door device for paper shredder according to claim 1 or 2, characterized in that the guide plate is further configured with a third chute which is in horizontal direction, the guide plate support is configured in the third chute, and the guide plate can slide horizontally on the guide plate support.

6. The rotary cutter door device for paper shredder according to claim 5, characterized in that there are two guide plate supports, one is configured under the guide plate and the other is configured in the third chute.

7. The rotary cutter door device according to claim 6, characterized in that there are three guide plate supports, the guide plate is further configured with a fourth chute which is in horizontal direction and the third guide plate support is configured in the fourth chute.

8. The rotary cutter door device for paper shredder according to claim 7, characterized in that there are four guide plate supports and the fourth guide plate support is stuck and fixed under the guide plate.

9. A paper shredder, characterized in that it includes the rotary cutter door device according to any one of claim 1-6.
